(19) United States
(12) Patent Application Publication
(10) Pub. No.: US 2013/0226755 A1
(43) Pub. Date: Aug. 29, 2013

(54) SYSTEMS AND METHODS FOR ENCOURAGING PAYMENT CARD USE

(71) Applicant: Michael J. Friedman, Norwalk, CT (US)

(72) Inventor: Michael J. Friedman, Norwalk, CT (US)

(21) Appl. No.: 13/406,871

(22) Filed: Feb. 28, 2012

(51) Int. Cl. G06Q 20/34

(52) U.S. Cl. 705/35

(57) ABSTRACT

A method and an account management computer system programmed to generate a scorecard having at least one target, wherein each target of the at least one target represents a transaction performed by a cardholder. The account management computer system is further programmed to receive account usage information from an interchange network, and determine whether the at least one target has been achieved based on the account usage information.

### BACKGROUND OF THE INVENTION

The field of the invention relates generally to systems and methods for encouraging consumer spending and, more particularly, to network-based systems and methods for using game mechanics to encourage payment card use.

The use of at least some known payment cards is incentivized with a rewards program that translates an amount of money spent to points awarded. Such points may be redeemed or used for a variety of rewards, such as discounts on merchandise, free merchandise, and/or reductions in outstanding balances on payment card accounts, among other things. The number of points accrued for a transaction may be based on the goods or services purchased during the transaction. For example, purchases at gas stations may accrue points at twice the rate of purchases made at department stores. Generally, known reward programs incentivize higher volumes of transaction amounts.

Accordingly, there is a need to incentivize specific consumer spending behavior. Some cardholders, such as younger demographic cardholders, often times respond to different methods of encouraging spending behaviors as compared to more traditional cardholders. For example, younger cardholders tend to use on-line methods of payment and purchasing more readily than traditional cardholders. Additionally, younger cardholders have been exposed to game technology and are therefore more receptive to its use as compared to the more traditional cardholders. Methods that incorporate on-line use and game mechanics to incentivize use of payment card accounts have, until now, been untried.

Accordingly, a method and a system that uses on-line game mechanics to incentivize cardholders, such as younger cardholders, to timely pay their payment card account debts and to more frequently use their payment cards to make purchases is needed.

### BRIEF DESCRIPTION OF THE INVENTION

In one embodiment, an account management computer system for use in managing account usage by a cardholder is provided. The computer system includes a memory device and a processor, and is in communication with an interchange network. The account management computer system is programmed to generate a scorecard having at least one target. Each target represents a transaction performed by the cardholder. The system is further programmed to receive account usage information from the interchange network and determine whether the at least one target has been achieved based on the account usage information.

In another embodiment, a computer-based method for encouraging payment account activity by a cardholder is provided. The method uses a computer device in communication with an interchange network. The method includes generating a scorecard having at least one target, wherein each target represents a transaction performed by the cardholder, receiving account usage information from the interchange network, and determining whether the at least one target has been achieved based on the account usage information.

In yet another embodiment, at least one non-transitory computer-readable storage media having computer-executable instructions embodied thereon is provided. The instructions are executed by at least one processor causing the processor to generate a scorecard having at least one target. Each target represents a transaction performed by a cardholder. The processor is further caused to receive account usage information from the interchange network and determine whether the at least one target has been achieved based on the account usage information.

### BRIEF DESCRIPTION OF THE DRAWINGS

FIGS. 1-9 show exemplary embodiments of the methods and systems described herein.

FIG. 1 is a schematic diagram illustrating an exemplary multi-party payment card industry system for enabling ordinary payment-by-card transactions in which merchants and card issuers do not necessarily have a one-to-one relationship.

FIG. 2 is a simplified block diagram of an exemplary system including a payment card account management computer device in accordance with one example embodiment of the present invention.

FIG. 3 is an expanded block diagram of an exemplary embodiment of a server architecture of the system including the plurality of computer devices in accordance with one example embodiment of the present invention.

FIG. 4 illustrates an exemplary configuration of a client system shown in FIGS. 2 and 3.

FIG. 5 illustrates an exemplary configuration of a server system shown in FIGS. 2 and 3.

FIG. 6 is a schematic block diagram of the payment card account management system shown in FIG. 2 in accordance with an exemplary embodiment of the present invention.

FIG. 7 is a data flow diagram of the payment card account management system shown in FIG. 2 in accordance with an exemplary embodiment of the present invention.

FIG. 8 is a schematic view illustrating an exemplary scorecard that may be used with embodiments of the present invention.

FIG. 9 is a flow diagram of a computer-based method for encouraging payment card use using a computer device coupled to a database.

### DETAILED DESCRIPTION OF THE INVENTION

Embodiments of the present invention combine game playing and a user interface that shows a scorecard to encourage payment card use. The methods and systems described herein encourage consumers to make purchases using payment cards and to pay off their payment card debts by providing such consumers with access to online game technology. Such online game technology prompts a user to play a game which includes making purchases with their payment cards and paying off debt associated with the payment card. In one embodiment, a payment card account management system presents a scorecard with a plurality of targets to a cardholder. Targets may include, but are not limited to, purchasing certain items, purchasing certain dollar amounts, interacting with the account management system in pre-determined ways (e.g., by logging in a pre-determined number of times, etc.), and/or paying off a pre-determined amount of an account balance. Targets may be visualized, for example, as squares on a Bingo card, and rewards may be given to cardholders for completing patterns, or goals, on the card (e.g., picture frame, blackout, etc.). By rewarding cardholder achievement of pre-determined goals, cardholder activity is incentivized using an interactive online game.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transactions card can be used as a method of payment for performing a transaction. In addition, consumer card account behavior can include but is not limited to purchases, management activities (e.g. balance checking), bill payments, achievement of targets (meeting account balance goals, paying bills on time), and/or product registrations (e.g. mobile application downloads).

In one embodiment, a computer program is provided, and the program is embodied on a computer readable medium. In an exemplary embodiment, the system is executed on a single computer system, without requiring a connection to a sever computer. In a further exemplary embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

The following detailed description illustrates embodiments of the invention by way of example and not by way of limitation. It is contemplated that the invention has general application to processing financial transaction data by a third party in industrial, commercial, and residential applications.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present invention are not intended to be interpreted as excluding the existence of additional embodiments that also incorporate the recited features.

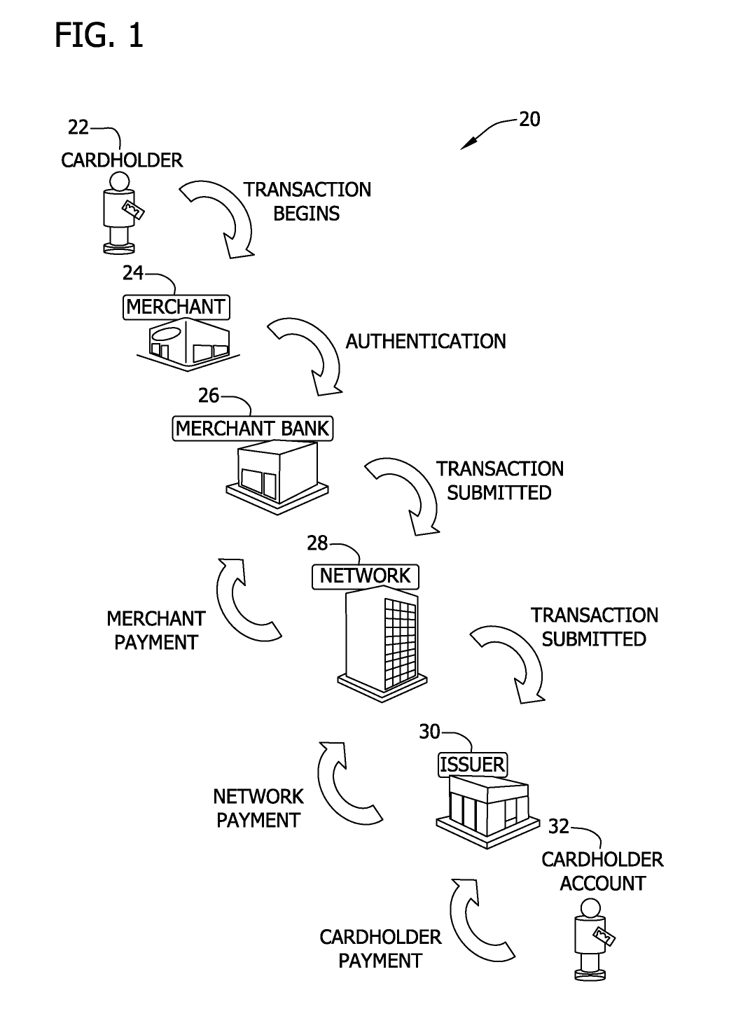

FIG. 1 is a schematic diagram illustrating an exemplary multi-party transaction card industry system 20 for enabling ordinary payment-by-card transactions in which merchants 24 and card issuers 30 do not need to have a one-to-one special relationship. Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, New York).

In a typical transaction card system, a financial institution called the “issuer” issues a transaction card, such as a credit card, to a consumer or cardholder 22, who uses the transaction card to tender payment for a purchase from a merchant 24. To accept payment with the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card, merchant 24 requests authorization from a merchant bank 26 for the amount of the purchase. The request may be performed over the telephone, but is usually performed through the use of a point-of-sale terminal, which reads cardholder's 22 account information from a magnetic stripe, a chip, or embossed characters on the transaction card and communicates electronically with the transaction processing computers of merchant bank 26. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether cardholder's 22 account 32 is in good standing and whether the purchase is covered by cardholder's 22 available credit line. Based on these determinations, the request for authorization will be declined or accepted. If the request is accepted, an authorization code is issued to merchant 24.

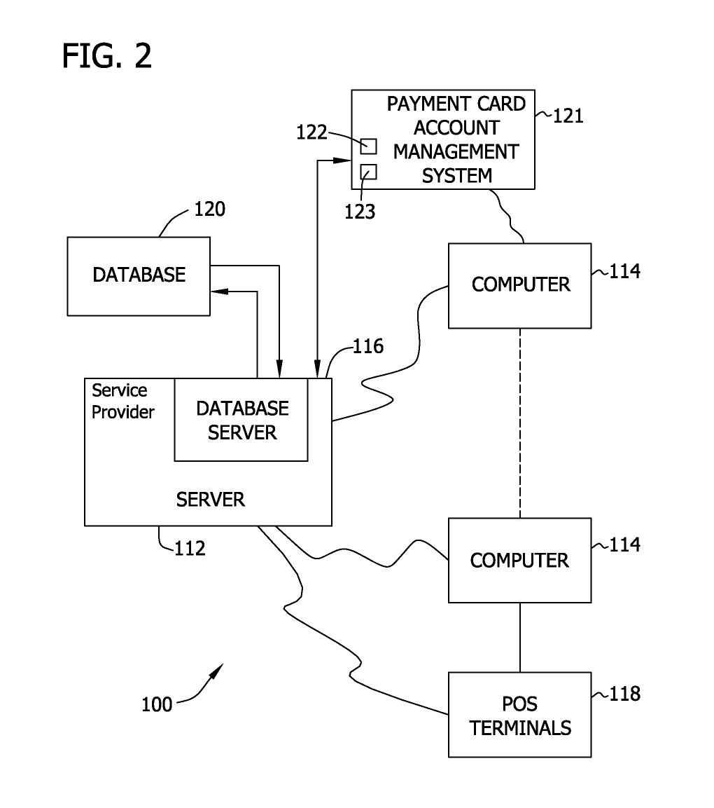

When a request for authorization is accepted, the available credit line of cardholder's 22 account 32 is decreased. Normally, a charge for a payment card transaction is not posted immediately to cardholder's 22 account 32 because bankcard associations, such as MasterCard International Incorporated®, have promulgated rules that do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns goods after the transaction has been captured, a “credit” is generated. Interchange network 28 and/or issuer bank 30 stores the transaction card information, such as a type of merchant, amount of purchase, date of purchase, in a database 120 (shown in FIG. 2).

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction. In the exemplary embodiment, when cardholder 22 purchases travel, such as airfare, a hotel stay, and/or a rental car, at least partial itinerary information is transmitted during the clearance process as transaction data. When interchange network 28 receives the itinerary information, interchange network 28 routes the itinerary information to database 120.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

FIG. 2 is a simplified block diagram of an exemplary processing system 100 including a plurality of computer devices, such as a payment card account management computer device, in accordance with one embodiment of the present invention. In the example embodiment, system 100 may be used for performing payment-by-card transactions received as part of processing the financial transaction.

More specifically, in the example embodiment, system 100 includes a server system 112, and a plurality of client sub-systems, also referred to as client systems 114, connected to server system 112. In one embodiment, client systems 114 are computers including a web browser, such that server system 112 is accessible to client systems 114 using the Internet. Client systems 114 are interconnected to the Internet through many interfaces including a network, such as a local area network (LAN) or a wide area network (WAN), dial-in-connections, cable modems, and special high-speed Integrated Services Digital Network (ISDN) lines. Client systems 114 could be any device capable of interconnecting to the Internet including a web-based phone, PDA, or other web-based connectable equipment.

System 100 also includes point-of-sale (POS) terminals 118, which may be connected to client systems 114 and may be connected to server system 112. POS terminals 118 are interconnected to the Internet through many interfaces including a network, such as a local area network (LAN) or a wide area network (WAN), dial-in-connections, cable modems, wireless modems, and special high-speed ISDN lines. POS terminals 118 could be any device capable of interconnecting to the Internet and including an input device capable of reading information from a consumer's financial transaction card.

A database server 116 is connected to database 120, which contains information on a variety of matters, as described below in greater detail. In one embodiment, centralized database 120 is stored on server system 112 and can be accessed by potential users at one of client systems 114 by logging onto server system 112 through one of client systems 114. In an alternative embodiment, database 120 is stored remotely from server system 112 and may be non-centralized.

Database 120 may include a single database having separated sections or partitions or may include multiple databases, each being separate from each other. Database 120 may store transaction data generated as part of sales activities conducted over the processing network including data relating to merchants, account holders or customers, issuers, acquirers, and/or purchases made. Database 120 may also store account data including at least one of a cardholder name, a cardholder address, an account number, and other account identifier. Database 120 may also store merchant data including a merchant identifier that identifies each merchant registered to use the network, and instructions for settling transactions including merchant bank account information. Database 120 may also store purchase data associated with items being purchased by a cardholder from a merchant, and authorization request data.

In the exemplary embodiment, one of client systems 114 may be associated with acquirer bank 26 (shown in FIG. 1) while another one of client systems 114 may be associated with issuer bank 30 (shown in FIG. 1). POS terminal 118 may be associated with a participating merchant 24 (shown in FIG. 1) or may be a computer system and/or mobile system used by a cardholder making an on-line purchase or payment. Server system 112 may be associated with interchange network 28. In the exemplary embodiment, server system 112 is associated with a network interchange, such as interchange network 28, and may be referred to as an interchange computer system. Server system 112 may be used for processing transaction data. In addition, client systems 114 and/or POS terminal 118 may include a computer system associated with at least one of an online bank, a bill payment outsourcer, an acquirer bank, an acquirer processor, an issuer bank associated with a transaction card, an issuer processor, a remote payment system, and/or a biller.

Further, a payment card account management system 121 may be included in client systems 114 or optionally may be included in server system 112. In the exemplary embodiment, payment card account management system 121 includes a memory device 122 and a processor 123 in communication with memory device 123. In various embodiments, payment card account management system 121 may be associated with a standalone processor or may be associated with a separate third party provider in a contractual relationship with interchange network 28 and configured to perform the functions described herein. Accordingly, each party involved in processing transaction data are associated with a computer system shown in system 100 such that the parties can communicate with one another as described herein.

Using the interchange network, the computers of the merchant bank or the merchant processor will communicate with the computers of the issuer bank to determine whether the consumer's account is in good standing and whether the purchase is covered by the consumer's available credit line. Based on these determinations, the request for authorization will be declined or accepted. If the request is accepted, an authorization code is issued to the merchant.

When a request for authorization is accepted, the available credit line of consumer's account is decreased. Normally, a charge is not posted immediately to a consumer's account because bankcard associations, such as MasterCard International Incorporated®, have promulgated rules that do not allow a merchant to charge, or “capture,” a transaction until goods are shipped or services are delivered. When a merchant ships or delivers the goods or services, the merchant captures the transaction by, for example, appropriate data entry procedures on the point-of-sale terminal. If a consumer cancels a transaction before it is captured, a “void” is generated. If a consumer returns goods after the transaction has been captured, a “credit” is generated.

For debit card transactions, when a request for a PIN authorization is approved by the issuer, the consumer's account is decreased. Normally, a charge is posted immediately to a consumer's account. The bankcard association then transmits the approval to the acquiring processor for distribution of goods/services, or information or cash in the case of an ATM.

After a transaction is captured, the transaction is settled between the merchant, the merchant bank, and the issuer. Settlement refers to the transfer of financial data or funds between the merchant's account, the merchant bank, and the issuer related to the transaction. Usually, transactions are captured and accumulated into a “batch,” which is settled as a group.

The financial transaction cards or payment cards discussed herein may include credit cards, debit cards, a charge card, a membership card, a promotional card, prepaid cards, and gift cards. These cards can all be used as a method of payment for performing a transaction. As described herein, the term “financial transaction card” or “payment card” includes cards such as credit cards, debit cards, and prepaid cards, but also includes any other devices that may hold payment account information, such as mobile phones, personal digital assistants (PDAs), key fobs, or other devices, etc.

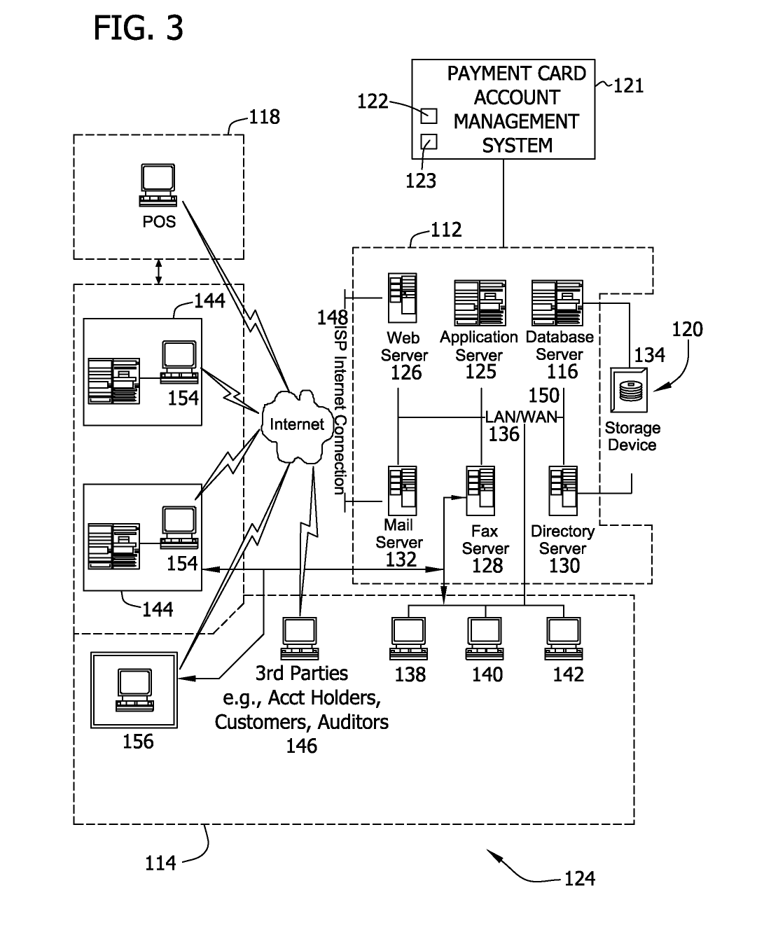

FIG. 3 is an expanded block diagram of an exemplary embodiment of a server architecture of a processing system 124 including other computer devices in accordance with one embodiment of the present invention. Components in system 124, identical to components of system 100 (shown in FIG. 2), are identified in FIG. 3 using the same reference numerals as used in FIG. 2. System 124 includes server system 112, client systems 114, and POS terminals 118, and payment card account management system 121. Server system 112 further includes database server 116, a transaction server 125, a web server 126, a fax server 128, a directory server 130, and a mail server 132. A storage device 134 is coupled to database server 116 and directory server 130. Servers 116, 125, 126, 128, 130, and 132 are coupled in a local area network (LAN) 136. In addition, a system administrator's workstation 138, a user workstation 140, and a supervisor's workstation 142 are coupled to LAN 136. Alternatively, workstations 138, 140, and 142 are coupled to LAN 136 using an Internet link or are connected through an Intranet.

Each workstation 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties, e.g., account holders, customers, auditors, developers, consumers, merchants, acquirers, issuers, etc., 146 using an ISP Internet connection 148. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150.

In the exemplary embodiment, any authorized individual having a workstation 154 can access system 124. At least one of the client systems includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems 138, 140, and 142 as well.

Payment card account management system 121 is in communication with server system 112 and in communication with client systems 114 and other workstations through a network connection.

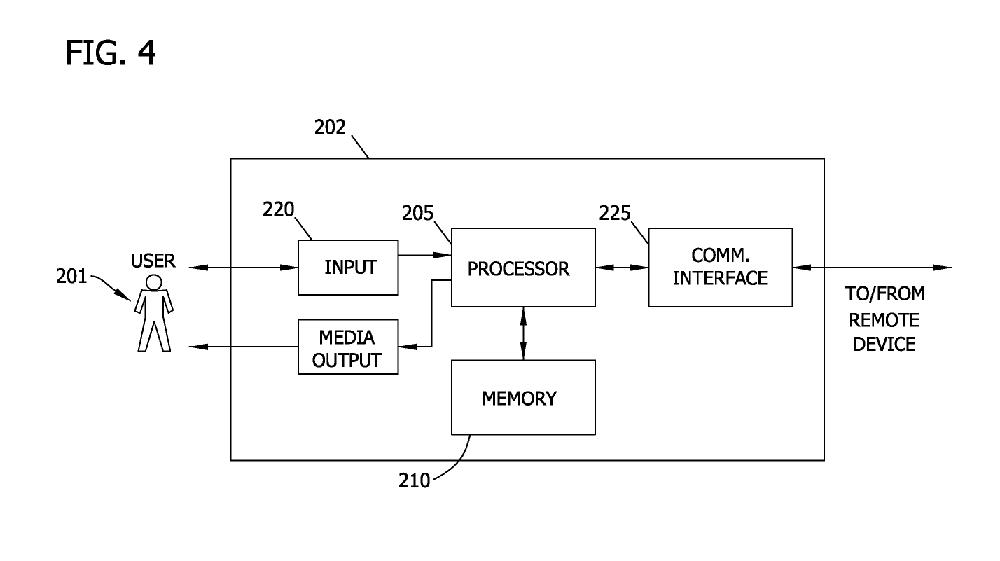

FIG. 4 illustrates an exemplary configuration of a user system 202 operated by a user 201, such as cardholder 22 (shown in FIG. 1). User system 202 may include, but is not limited to, client systems 114, 138, 140, and 142, POS terminal 118, workstation 154, and manager workstation 156. In the exemplary embodiment, user system 202 includes a processor 205 for executing instructions. In some embodiments, executable instructions are stored in a memory area 210. Processor 205 may include one or more processing units, for example, a multi-core configuration. Memory area 210 is any device allowing information such as executable instructions and/or written works to be stored and retrieved. Memory area 210 may include one or more computer readable media.

User system 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively couplable to an output device such as a display device, a liquid crystal display (LCD), organic light emitting diode (OLED) display, or “electronic ink” display, or an audio output device, a speaker or headphones.

In some embodiments, user system 202 includes an input device 220 for receiving input from user 201. Input device 220 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 215 and input device 220. User system 202 may also include a communication interface 225, which is communicatively couplable to a remote device such as server system 112. Communication interface 225 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable users, such as user 201, to display and interact with media and other information typically embedded on a web page or a website from server system 112. A client application allows user 201 to interact with a server application from server system 112.

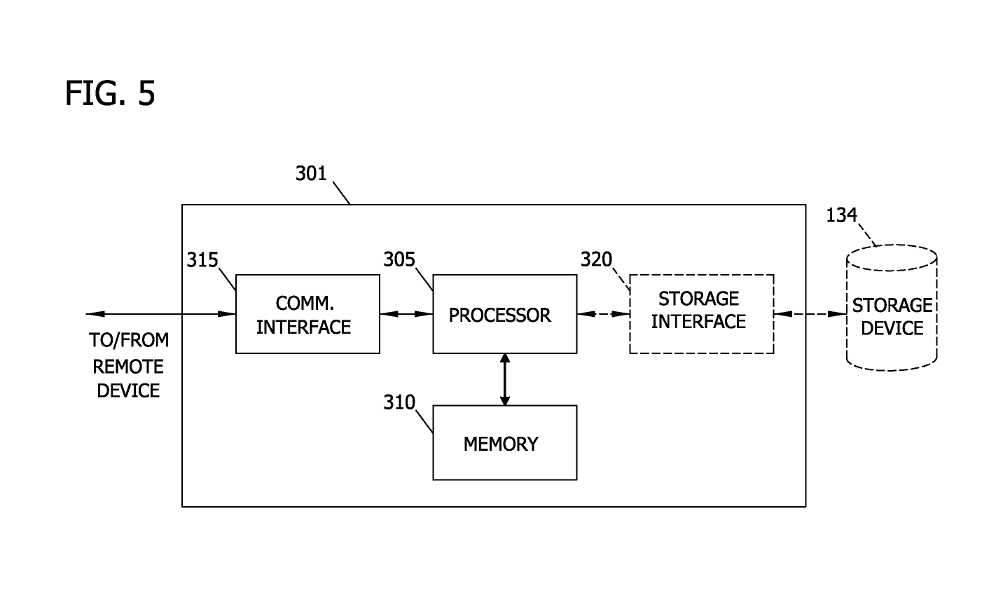

FIG. 5 illustrates an exemplary configuration of a server system 301 such as server system 112 (shown in FIGS. 2 and 3). Server system 301 may include, but is not limited to, database server 116, application server 125, web server 126, fax server 128, directory server 130, and mail server 132.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc).

Processor 305 is operatively coupled to a communication interface 315 such that server system 301 is capable of communicating with a remote device such as a user system or another server system 301. For example, communication interface 315 may receive requests from user system 114 via the Internet, as illustrated in FIGS. 2 and 3.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

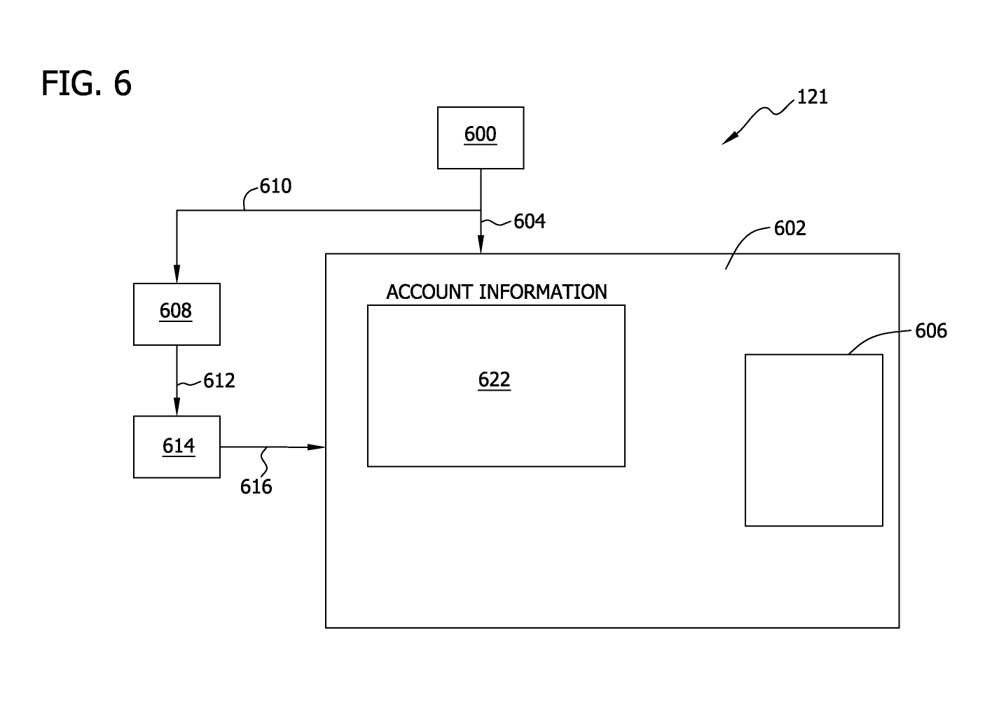

FIG. 6 is a schematic block diagram of an exemplary payment card account management system 121 (shown in FIG. 2) for use with network 28. In the exemplary embodiment, payment card account management system 121 includes a data store 600 containing account information, a user interface (UI) 602 configured to receive account information 604 from data store 600 and to convey the account information 604 to a user, a user scorecard 606, a cardholder action target database 608 configured to convert consumer card account usage 610 into cardholder action targets 612, and a scorecard database 614 configured to store scorecards and analyze targets 612. Account usage 610 information may include any information available from or to network 28 relating to a cardholder, including, but not limited to, a cardholder profile, purchase activity, account payment activity, usage of network 28, and/or any other use of a payment card and/or network 28. Account usage 610 information is defined at least as broadly as transactions and/or targets, below. Account information is displayed in a card account management user interface 622 portion of UI 602.

In the exemplary embodiment, cardholder action target database 608 contains one or more scoring rules, referred to herein as “targets,” that may be triggered by pre-determined account usage 610. A target is a desired user action that may be detected by management system 121 based on account usage 610, use of management system 121, and/or any data available to management system 121. Targets may be selected to promote specific aims of card issuers, merchants, processors, and/or networks. Targets 612 are represented in target database 608 such that database 608 is able to correlate specific account usage 610 to pre-determined targets 612. More particularly, target database 608 may use authorization or clearing data from network 28 (shown in FIG. 1) to determine if a target 612 has been achieved. Each target represents a transaction (e.g., performing a purchase, accessing a cardholder account, making a payment to a cardholder account, etc.) performed over or using network 28 and/or system 121. Targets may include, but are not limited to: spending an amount within a pre-determined range, using a payment card at a particular merchant, using a payment card to buy a pre-determined class of goods or services, using a pre-determined payment method (e.g., online, contactless), conducting a pre-determined number of transactions within a pre-determined time period, and/or any pre-determined interaction with system 20, network 28, and/or system 121. For example, targets may include, but are not limited to: paying down an account balance to a pre-determined amount, making a payment on a cardholder account, buying coffee, using a payment card at a grocery store, using a payment card in a locale that is different than the locale of the user's billing address, using a payment card to buy lunch, using a payment card to make a purchase online, logging into a cardholder account, and/or using a payment card three times on a weekend, among other things and in any combination of the foregoing.

In the exemplary embodiment, scorecard database 614 stores scorecards 606. Each scorecard 606 includes a plurality of targets and, accordingly, each target within scorecard 606 is represented in target database 608. As scorecards 606 may be customized for each user, scorecard database 614 stores each unique scorecard 606 along with an association between a user's scorecard 606 and the user. In addition, as a target is achieved, scorecard database 614 stores an indication that a particular user achieved a particular target. In other words, target database 608 is configured to determine when a user achieves a target on scorecard 606 of the user, and scorecard database 614 is configured to store scorecard 606 and an indication of which targets on scorecard 606 the user has achieved. Though target database 608 and scorecard database 614 are illustrated as two separate databases, databases 608 and 614 may be implemented using a single system and/or database.

Previously-achieved targets may be marked as un-achieved if the user action that caused the target to be achieved is reversed. In other words, as transactions within card usage 610 may be voided, reversed, or otherwise canceled, provision is made for voiding corresponding target achievements. For example, if a user achieves a target of spending more than $1,000 in a single transaction by buying an item, and later returns that item, the achievement indicator for that target may be removed. Accordingly, cheating on scorecard 606 is reduced by requiring that card usage 610 is not temporary for purposes of achieving targets.

Scorecard database 614 may also store goals associated with each scorecard 606. Goals are a pre-determined collection of targets designed to entice the user to achieve additional and/or specific targets. Goals are often coupled with rewards that are offered to the user for completing a goal. For example, a user may be offered a reward for achieving certain targets or for achieving a pre- determined number of targets. Additionally, goals may include other restraints, such as a time period or geographic region. For example, a goal might require that at least four targets are achieved in a pre-determined city during a pre-determined week. As the role of the goal is to entice certain buying activities, goals may be selected for a user based on past account usage, such that a user is more likely to be enticed by a goal. For example, if past account usage indicates that a user typically spends $500 on a weekend, a goal may be selected that includes spending $750 on a weekend. Thus, goals may be selected that are both achievable by the user and useful in increasing user spending. Scorecard 606 may have more than one goal, and a goal may be associated with more than one scorecard, e.g., to every user of system 121.

In one embodiment, two or more users may compete against each other to achieve one or more goals on scorecard 606. Scorecard 606 may be presented to more than one user, and each user may compete against other users, e.g., friends, to achieve a goal, e.g., achieving all targets, before the other users. An additional incentive may be provided for winning such a competition. Rather than competing to complete an identical scorecard 606, two or more users may compete to complete their own scorecard 606, or a scorecard of another user, which may be different than the scorecards of the other users.

In one embodiment, UI 602 may be accessed and displayed on a PC or client workstation, such as, but not limited to, client system 114 connected to server system 112. In various embodiments, UI 602 may be accessed via an app downloaded to a portable handheld device such as, but not limited to, a smartphone. Users may be notified of new scorecards, new goals, achieved targets, achieved goals, etc. using UI 602 and/or by any suitable means, e.g., email or SMS message.

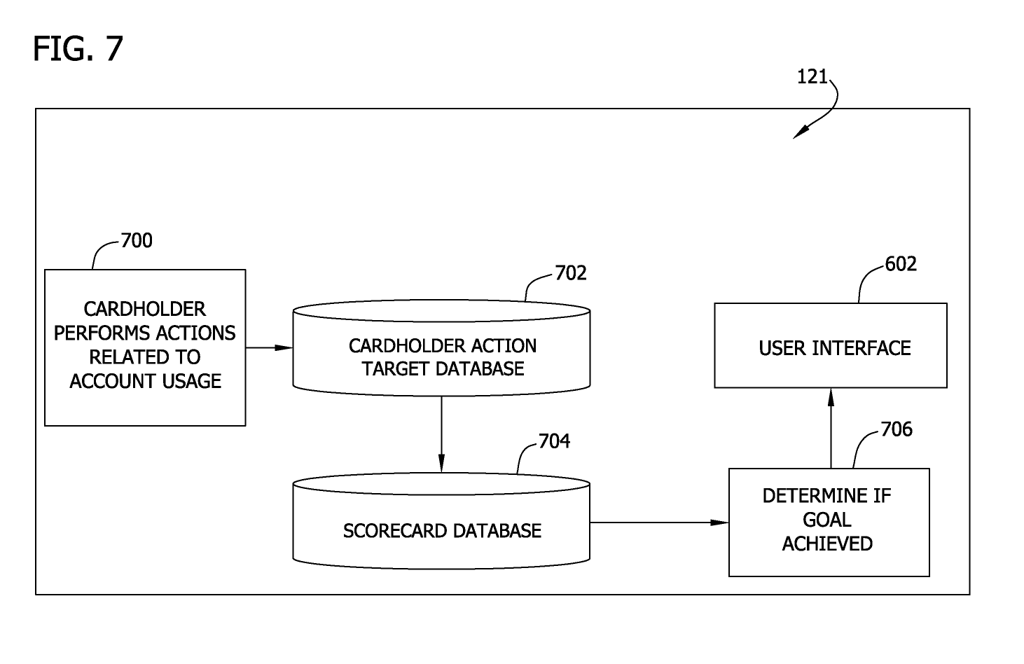

FIG. 7 is an exemplary flow diagram of payment card account management system 121. In the exemplary embodiment, a user interacts 700 with the payment card account associated with the user, typically by using the payment card in transactions. Payment card account management system 121 translates 702 the payment card usage 610 into targets 612 using information stored in target database 608 (shown in FIG. 6). If a target is found on a user scorecard 606, scorecard database 614 is updated 704 to indicate that the target or targets have been achieved. User scorecard 606 is analyzed to determine 706 whether one or more goals have been achieved. User scorecard 606 is then updated on UI 602 to depict targets and goals that have been achieved. Accordingly, a user will be able to determine, by viewing UI 602, the status of scorecard 606. More particularly, the user will be able to determine which targets need to be achieved in order to achieve the desired goal of the user.

Alternatively, system 121 may determine whether the targets on scorecard 606 have been achieved by first determining which targets are on scorecard 606 and then analyzing payment card usage 610. In other words, rather than translating usage 610 into targets 612 and determining whether targets 612 are on scorecard 612, system 121 may only analyze usage 610 to determine if the targets on scorecard 606 were achieved.

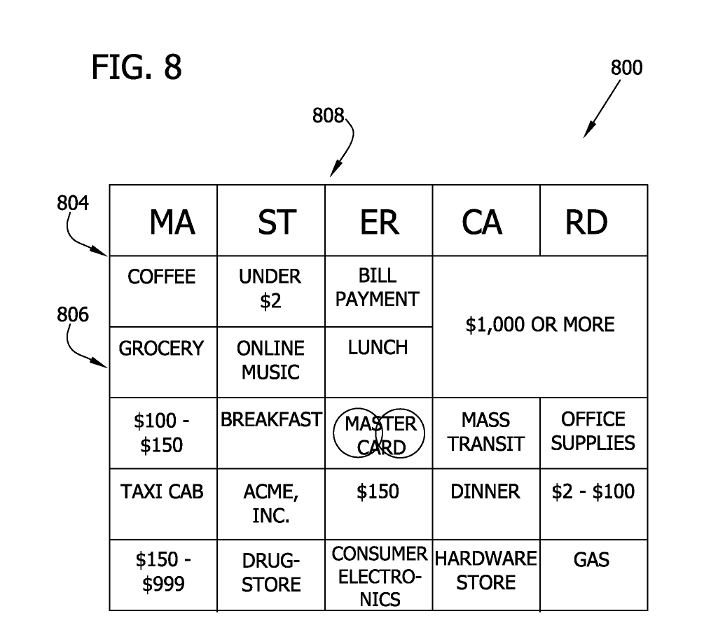

FIG. 8 is a schematic view illustrating an exemplary scorecard 800 that may be used with system 121. In the exemplary embodiment, scorecard 800 is a matrix, or substantially grid-like. A plurality of targets 804 are displayed in rows 806 and columns 808 within scorecard 800. Each target 804 is displayed within a box that contains text that describes target 804. A visual indicator, such as a color, icon, outline, etc., may be used to indicate that a target has been achieved. For example, boxes representing achieved targets may have a color that is different than targets that have not been achieved. Likewise, a visual goal indicator, such as a color, icon, outline, etc., may be used to designate the status of pre-determined goals. For example, darkening grid lines around boxes may designate a goal. Alternatively, a goal may include all targets 804 on scorecard 800 and may not be visually designated on scorecard 800. The pre-determined targets included in a goal may be based on the layout or position of the targets on scorecard 800. For example, a goal may be, but is not limited to, known winning conditions or patterns in the game of Bingo, such as completed columns, rows, picture frames, diagonals, black-outs, four-corners, six-packs, picnic tables, railroad tracks, letters, and/or plus signs.

Alternatively, scorecard 800 may display targets in any manner that enables card management system 121 to function as described herein. For example, scorecard 800 may use images rather than text to represent a target, such as an image of a hamburger to represent fast food. As a further example, targets may be represented as bases on a baseball diamond, and a goal may be to achieve each of the four target bases, whether in order or otherwise. Scorecard 800 may display targets in accordance with any theme and/or game, including, but not limited to, sports, carnival/midway games, board games, casino games, and the like. Scorecard 800 may list targets and indicate that a goal is to achieve a pre-determined number of targets.

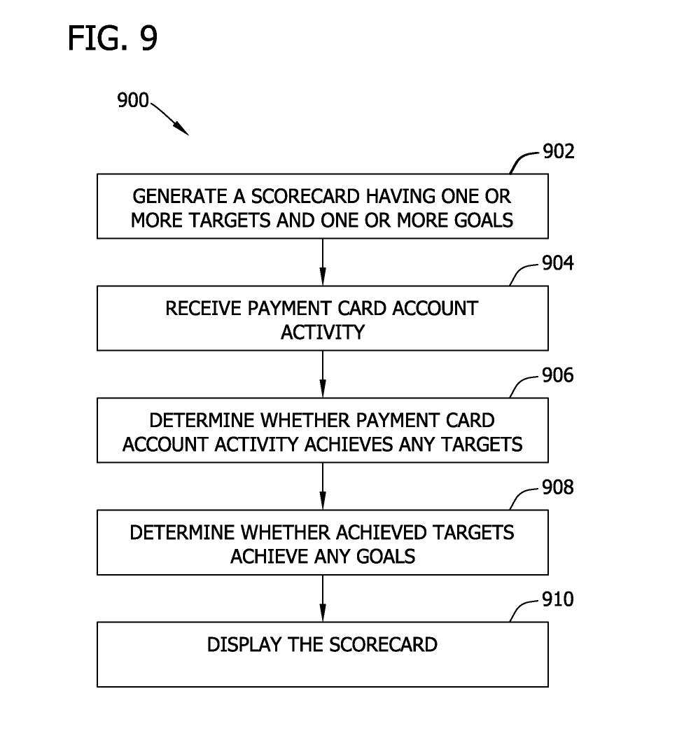

FIG. 9 is a flow diagram of a computer-based method 900 for encouraging payment card use using a computer device coupled to a database. In the exemplary embodiment, method 900 includes generating 902 a scorecard that includes targets and goals, the targets representing pre-determined cardholder account activity and the goals representing rewards and incentives for achieving pre-determined targets associated with the scorecard. Method 900 further includes receiving 904 payment card account activity from a network, the payment card account activity including transactions and other account usage by the cardholder. Method 900 further includes determining 906 whether payment card account activity satisfies any target on the scorecard. It is then determined 908 whether the achieved targets on the scorecard complete any of the pre-determined goals. The scorecard is then displayed 910 to the user with an indication of all targets and goals and the status of each target and goal (i.e., achieved versus unachieved).

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are exemplary only, and are thus not limiting as to the types of memory usable for storage of a computer program.

As will be appreciated based on the foregoing specification, the above-described embodiments of the disclosure may be implemented using computer programming or engineering techniques including computer software, firmware, hardware or any combination or subset thereof, wherein the technical effect is generating a scorecard having one or more targets and one or more goals, receiving payment card account activity, determining whether payment card account activity achieves any targets, determining whether achieved targets complete any goals, and displaying the scorecard to a user with an indication of the status of each target and goal. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

The above-described embodiments of methods and systems of encouraging consumer spending and/or payment card use provide a cost-effective and reliable means for providing targets and goals to cardholders to reward pre-determined spending behavior and patterns. As a result, the methods and systems described herein facilitate encouraging consumer spending and/or payment card use using a game that provides challenges and rewards.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An account management computer system for use in managing account usage by a cardholder, said computer system comprising a memory device and a processor, and is in communication with an interchange network, the account management computer system programmed to:
generate a scorecard having at least one target, wherein each target of the at least one target represents a transaction performed by the cardholder;
receive account usage information from the interchange network; and
determine whether the at least one target has been achieved based on the account usage information.

2. A system in accordance with claim 1, wherein the account management computer system is further programmed to determine whether at least one goal has been achieved by the cardholder based on targets achieved on the scorecard of the at least one target, wherein each goal represents a pre-determined collection of targets.

3. A system in accordance with claim 2, wherein the account management computer system is further programmed to display the scorecard to a user.

4. A system in accordance with claim 3, wherein the scorecard comprises a plurality of targets arranged in a matrix.

5. A system in accordance with claim 4, wherein the pre-determined collection of targets are based on the location of targets in the matrix.

6. A system in accordance with claim 3, wherein the scorecard comprises a plurality of targets visualized as bases on a baseball diamond.

7. A system in accordance with claim 6, wherein the pre-determined collection of targets comprises each of the bases on the baseball diamond.

8. A system in accordance with claim 1, wherein each target of the at least one target represents at least one of a transaction amount, a type of merchant type, a merchant location, a payment method, and a type of merchandise.

9. A system in accordance with claim 1, wherein the account management computer system is further programmed to determine which cardholder from a pre-determined collection of cardholders achieves all targets on the scorecard first.

10. A computer-based method for encouraging payment account activity by a cardholder using a computer device in communication with an interchange network, said method comprising:
generating, by a processor, a scorecard having at least one target, wherein each target of the at least one target represents a transaction performed by the cardholder;
receiving account usage information from the interchange network; and
determining, by a processor, whether the at least one target has been achieved based on the account usage information.

11. A method in accordance with claim 10, further comprising determining whether at least one goal has been achieved by the cardholder based on targets achieved on the scorecard of the at least one target, wherein each goal represents a pre-determined collection of targets.

12. A method in accordance with claim 11, further comprising displaying the scorecard to a user.

13. A method in accordance with claim 12, wherein displaying the scorecard to a user comprises displaying a plurality of targets in a matrix.

14. A method in accordance with claim 13, wherein determining whether the at least one goal has been achieved comprises determining whether a pattern of targets on the matrix has been achieved.

15. A method in accordance with claim 14, wherein determining whether a pattern of targets on the matrix has been achieved comprises determining whether a blackout pattern has been achieved.

16. A method in accordance with claim 12, wherein displaying the scorecard to a user comprises displaying a plurality of targets as bases on a baseball diamond.

17. A method in accordance with claim 16, wherein determining whether the at least one goal has been achieved comprises determining whether each of the bases on the baseball diamond has been achieved.

18. A method in accordance with claim 10, wherein generating a scorecard having at least one target comprises determining a target based on at least one of a transaction amount, a type of merchant, a merchant location, a payment method, and a type of merchandise.

19. A method in accordance with claim 11, further comprising determining which user from a pre-determined collection of users achieves a pre-determined goal first.

20. At least one non-transitory computer-readable storage media having computer-executable instructions embodied thereon, wherein when executed by at least one processor, the computer-executable instructions cause the processor to:
generate a scorecard having at least one target, wherein each target of the at least one target represents a transaction performed by a cardholder;
receive account usage information from an interchange network; and
determine whether the at least one target has been achieved based on the account usage information.

21. The computer-readable storage media of claim 20, wherein the computer-executable instructions further cause the processor to determine whether at least one goal has been achieved by the cardholder based on targets achieved on the scorecard of the at least one target, wherein each goal represents a pre-determined collection of targets.

22. The computer-readable storage media of claim 21, wherein the computer-executable instructions further cause the processor to display the scorecard to a user.

23. The computer-readable storage media of claim 22, wherein the scorecard comprises a plurality of targets arranged in a matrix.

24. The computer-readable storage media of claim 20, wherein each target represents at least one of a transaction amount, a type of merchant, a merchant location, a payment method, and a type of merchandise.
